(19) United States
(12) Patent Application Publication
(10) Pub. No.: US 2026/0212567 A1
(43) Pub. Date: Jul. 23, 2026

(54) VIDEO GENERATION METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Qin QIN, Beijing (CN); Zhiqiang WANG, Beijing (CN); Yang DENG, Beijing (CN)

(73) Assignee: BEIJING BAIDU NETCOM SCIENCE TECHNOLOGY CO., LTD., Beijing (CN)

(21) Appl. No.: 19/569,669

(22) Filed: Mar. 17, 2026

(30) Foreign Application Priority Data
Mar. 19, 2025 (CN) 202510330286.8

(51) Int. Cl. G06T 11/60; G06T 5/70; G06V 10/77; G06V 40/10

(52) U.S. Cl. CPC G06T 11/60; G06T 5/70; G06V 10/7715; G06V 40/107

(57) ABSTRACT

Provided is a video generation method, electronic device and storage medium, which relates to the field of artificial intelligence technology, and in particular to the fields of computer vision, deep learning, large models, and augmented reality. The method includes: extracting a reference feature of a target object from a reference image; determining a mixed pose sequence; wherein a plurality of target parts in the mixed pose sequence adopt a corresponding description mode to enhance a pose characteristic of a corresponding part; introducing initial noise to a denoising network, and performing a reverse denoising operation on the reference feature and the mixed pose sequence, to generate a video of the target object.

### CROSS-REFERENCE TO RELATED APPLICATIONS

The present application claims priority to Chinese Patent Application No. CN202510330286.8, filed with the China National Intellectual Property Administration on Mar. 19, 2025, the disclosure of which is hereby incorporated herein by reference in its entirety.

### TECHNICAL FIELD

The present disclosure relates to the field of artificial intelligence technology, and in particular to the fields of computer vision, deep learning, large models, and augmented reality, and can be applied to scenarios such as digital humans.

### BACKGROUND

With the rapid development of Internet technology and artificial intelligence, AI Agent generation technology provides technical support for digital human generation. Digital human generation has been widely used in application scenarios such as the metaverse, intelligent customer service, and e-commerce. Not only can it provide a more intuitive and personalized service experience but also significantly enhance user engagement and satisfaction.

### SUMMARY

The present disclosure provides a video generation method, apparatus, device, and storage medium.

According to an aspect of the present disclosure, a video generation method is provided, comprising:
extracting a reference feature of a target object from a reference image;
determining a mixed pose sequence; wherein a plurality of target parts in the mixed pose sequence adopt a corresponding description mode to enhance a pose characteristic of a corresponding part;
introducing initial noise to a denoising network, and performing a reverse denoising operation on the reference feature and the mixed pose sequence, to generate a video of the target object.

According to another aspect of the present disclosure, a video generation apparatus is provided, comprising:
a first extracting module configured to extract a reference feature of a target object from a reference image;
a second extracting module configured to determine a mixed pose sequence; wherein a plurality of target parts in the mixed pose sequence adopt a corresponding description mode to enhance a pose characteristic of a corresponding part;
a generating module configured to introduce initial noise to a denoising network, and perform a reverse denoising operation on the reference feature and the mixed pose sequence, to generate a video of the target object.

According to another aspect of the present disclosure, an electronic device is provided, comprising:
at least one processor; and
a memory connected in communication with the at least one processor;
wherein the memory stores an instruction executable by the at least one processor, and the instruction, when executed by the at least one processor, enables the at least one processor to execute the method of any embodiment of the present disclosure.

According to still another aspect of the present disclosure, a non-transitory computer-readable storage medium storing a computer instruction thereon is provided, and the computer instruction is used to cause a computer to execute the method of any embodiment of the present disclosure.

According to yet another aspect of the present disclosure, a computer program product including a computer program is provided, and the computer program, when executed by a processor, executes the method of any embodiment of the present disclosure.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are intended to provide a better understanding of the present solution and do not constitute a limitation on the present disclosure.

FIG. 1 is a schematic flowchart of a video generation method according to an embodiment of the present disclosure;

FIG. 2 is a schematic flowchart of extracting a mixed pose sequence from a driving signal according to an embodiment of the present disclosure;

FIG. 3 is a schematic diagram of various images required to obtain a mixed pose sequence according to an embodiment of the present disclosure;

FIG. 4 is a schematic flowchart of generating a video of a target object according to an embodiment of the present disclosure;

FIG. 5 is a schematic diagram of processing an input feature based on a denoising network according to an embodiment of the present disclosure;

FIG. 6 is a schematic diagram illustrating the working principle of a denoising module in a denoising network according to an embodiment of the present disclosure;

FIG. 7 is a schematic structural diagram showing interaction between a reference network and a denoising network according to an embodiment of the present disclosure;

FIG. 8 is another schematic structural diagram showing interaction between a reference network and a denoising network according to an embodiment of the present disclosure;

FIG. 9 is a schematic diagram of an overall architecture of a video generation method according to an embodiment of the present disclosure;

FIG. 10 is a schematic structural diagram of a video generation apparatus according to an embodiment of the present disclosure;

FIG. 11 is a block diagram of an electronic device for implementing a video generation method of the embodiments of the present disclosure.

### DETAILED DESCRIPTION

Exemplary embodiments of the present disclosure will be described below in combination with the accompanying drawings, which includes various details of the embodiments of the present disclosure to facilitate understanding and should be considered merely illustrative. Accordingly, those of ordinary skill in the art should recognize that various changes and modifications can be made to the embodiments described herein without departing from the scope of the present disclosure. Similarly, for the sake of clarity and conciseness, descriptions of well-known functions and structures are omitted from the following description.

With the continuous development of Internet technology and artificial intelligence, the application of digital humans has gradually expanded from a human face to an entire human body. The generated human motion videos can be used in scenarios such as digital human broadcasting and dance video generation.

The method for generating a human body movement typically relies on a reference image of a human body, with some driving signals serving as conditions to animate the reference image. Digital human video generation technology aims to produce videos of human body movements that are coherent in motion and clear in quality.

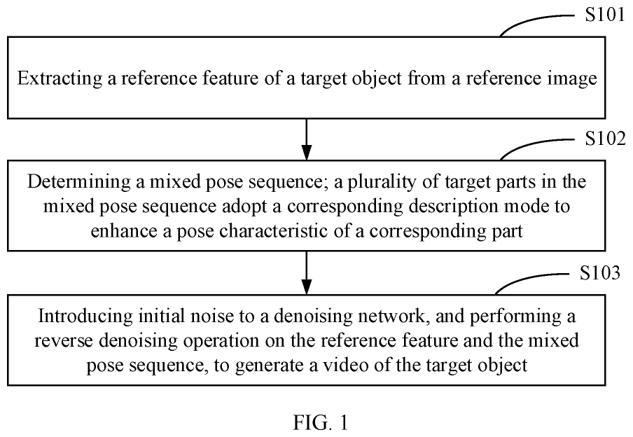

To enhance the quality of digital human video generation, an embodiment of the present disclosure presents a video generation method. As illustrated in FIG. 1, which is a flowchart of a video generation method provided in an embodiment of the present disclosure, the method comprises the following steps:
S101: extracting a reference feature of a target object from a reference image.

In a task of generating a video of a target object, a reference image is one of the inputs, which is an image containing the target object. The video generation method provided in the embodiments of the present disclosure can generate coherent movements of the target object based on a driving signal, thereby generating a video of the target object.

The reference image provides texture information such as identity and clothing of the target object, which is used to ensure that during the process of generating the video of the target object, the target object in the generated video has consistent key features with those in the reference image, thereby guaranteeing the quality of the generated video.

The reference feature extracted from the reference image is key feature data that can represent the target object. These reference features are usually extracted and encoded by an encoder for use in the subsequent video generation process, ensuring that the target object maintains a relatively stable appearance feature in the generated video.
S102: determining a mixed pose sequence; wherein a plurality of target parts in the mixed pose sequence adopt a corresponding description mode to enhance a pose characteristic of a corresponding part.

During implementation, a mixed pose sequence can be extracted from a driving signal. The driving signal is an input signal used to control the motion of the digital human. The mixed pose sequence extracted from the driving signal integrates various pose data, such as facial motion and body movement, to guide the production of the motion of the target object in the video.

Adopting a corresponding description for a plurality of target parts in a mixed pose sequence to enhance a pose characteristic of each part can express a motion feature required to be displayed by the target object in the generated video from different dimensions or angles. This enables a neural network in the generated video to focus independently on different target parts respectively, resulting in more accurate, smooth, and natural motion representation of the generated target object. For example, a human key point is used to describe a pose of a body (i.e., the torso and limbs), and 3D HandMesh is used to accurately describe a pose of a hand.

Therefore, the mixed pose sequence provided in the embodiments of the present disclosure can be understood as using different technical description methods to independently describe different target parts of the overall pose in the same driving signal. The poses used to drive the target object in the driving signal are not limited to the extraction methods of any specific technology or model.
S103: introducing initial noise to a denoising network, and performing a reverse denoising operation on the reference feature and the mixed pose sequence, to generate a video of the target object.

The initial noise is typically a random Gaussian noise, which is input into the denoising network along with the reference feature and the mixed pose sequence as a condition. This allows the denoising network to gradually reduce noise based on these inputs to generate a video of the target object.

A reverse denoising operation is the reverse process of the diffusion model, opposite to the forward diffusion process. In the forward diffusion process, original data is gradually added with noise and eventually transformed into pure noise data; whereas in the reverse denoising process, the model starts from pure noise data, gradually removes noise, and ultimately recovers the original data. Therefore, the denoising network, constructed based on the diffusion model, can recover the image of the target object from noise to generate a video.

In an embodiment of the present disclosure, a reference feature of a target object is extracted from a reference image, which can accurately describe the unique characteristics of the target object, such as identity, clothing, and other texture information, ensuring that the generated video conforms to the expected characteristics of the target person. A mixed pose sequence is extracted from a driving signal, which provides original control information, while the mixed pose sequence processes and adapts this information. This enables the digital human motion generation system to better guide the generation of the video of the target object and produce motions that meet expectations. The mixed pose sequence describes different target parts using a corresponding description mode, enhancing an inherent characteristic of the respective part and improving the quality of the input. This facilitates reasoning and understanding of the feature of an important target part during the video generation process, ultimately accurately understanding the pose characteristic, gradually generating a video that conforms to the feature of the target object and the pose requirement expressed by the driving signal from noise, improving the accuracy of the target object's pose in the generated video, making the pose changes in the video more stable and natural, and thus enhancing the quality of the generated video.

In an embodiment of the present disclosure, the plurality of target parts in the mixed pose sequence can include at least one of the following: face, hand, or parts of the body other than the hands. Because body movements (excluding the hands) involve a key point that is relatively discrete compared to the face and is less prone to occlusion, during the implementation, optimizing the representation in the mixed pose sequence for the face and/or the hands, which are more susceptible to occlusion, can be prioritized. To further ensure the accuracy of other body parts, the parts of the body other than the hands can also be optimized. By incorporating a specialized description of a target part into the mixed pose sequence in a differentiated manner, the understanding of a target part feature in the input signal can be enhanced. This ensures that the motions of the digital human in these key parts are more natural and lifelike in the generated target object video, thereby guaranteeing the identity consistency and motion stability in the generated target object video.

During implementation, a facial feature of the target part in the mixed pose sequence can be described using a facial key point; a hand of the target part can be described using a 3D grayscale model.

A 3D grayscale model typically refers to a model that represents a surface feature of a 3D object based on grayscale values. In the fields of computer vision and graphics, it can serve as an intermediate representation for describing the shape and other characteristics of an object.

During implementation, a hand pose obtained through a hand pose estimation model can be rendered to produce a 3D grayscale model of the hand. For example, a motion video can be used as a driving signal, with the intent of using the motion sequence of the reference object in the motion video to drive the target object. That is, it is required that in the generated video, the target object performs a same expression and motion as the reference object in the driving video. It can also be understood that the pose of the target object mimics that of the reference object. During implementation, the driving signal is input into a HaMer (Hand Mesh Recovery, a hand pose estimation model) network model. This network model extracts a hand rendering from the motion video, which is described based on the MANO (Hand Mesh and Model) 3D parametric hand mesh model of the reference object, thereby obtaining a 3D gray-scale mesh image of the hand.

In an embodiment of the present disclosure, the adoption of a 3D grayscale model for a hand in the target part of the mixed pose sequence allows for more accurate capture of subtle hand movements. Compared to a simple 2D image or a key point marker, a 3D grayscale model provides richer information, which helps to construct a more realistic hand model, making the generated video of the target object appear more natural and stable when involving hand operations.

Furthermore, to simplify the understanding and analysis of a hand movement in a target part and to visually and effectively distinguish between left and right hands, different colors are used to distinguish between the left and right hands in the target part of the mixed gesture sequence.

During implementation, different colors can be assigned to the left and right hands in the mixed gesture sequence, for example, using green to represent the left-hand and pink to represent the right-hand.

In an embodiment of the present disclosure, distinguishing the left and right hands using different colors in the mixed pose sequence enables the model to better differentiate between the left and right hands, thereby facilitating the reconstruction of the hand pose of the target object in the generated video. This improves the stability and accuracy of the reconstruction of the hand area in the generated video.

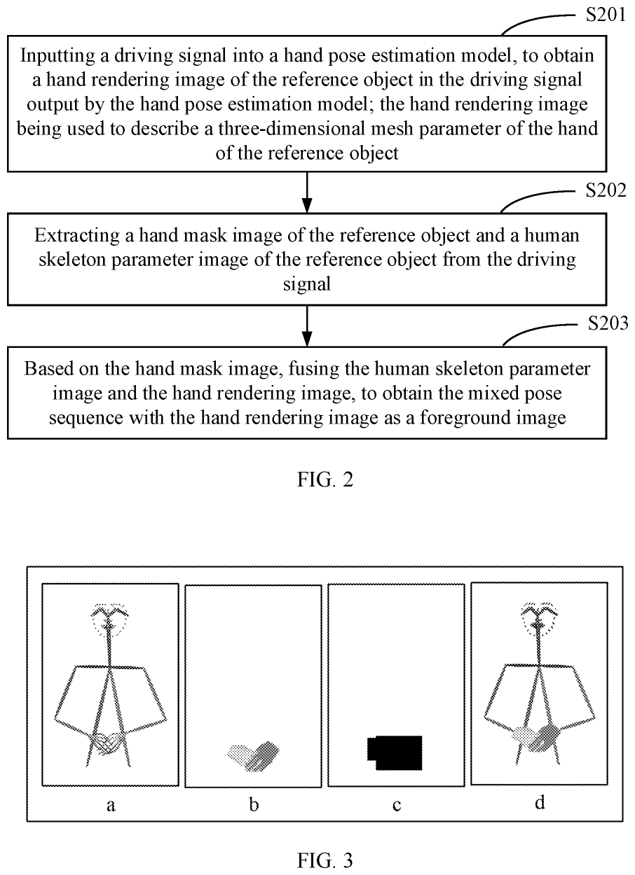

In an embodiment of the present disclosure, an implementation method for determining a mixed pose sequence can be as shown in FIG. 2, which includes:
S201: inputting a driving signal into a hand pose estimation model, to obtain a hand rendering image of the reference object in the driving signal output by the hand pose estimation model; wherein the hand rendering image is used to describe a three-dimensional mesh parameter of the hand of the reference object.

The hand pose estimation model is a deep learning model specifically designed to analyze and estimate hand poses. For instance, the HaMer model achieves high-precision 3D hand reconstruction through a single RGB image, obtaining hand pose parameters; the MANO model can map hand shape parameters, such as finger length and palm width, as well as pose parameters, such as joint angles, to a detailed 3D hand mesh.

During implementation, the image containing the hand in the driving signal can be input into the hand pose estimation model HaMer, and a pose parameter of the hand can be extracted based on this model. Then, based on the extracted pose parameter, the hand pose estimation model MANO is used to generate a 3D mesh model of the hand, which is rendered into a hand rendering image, as shown in panel b in FIG. 3. The hand rendering image provides 3D mesh parameter information of the hand, which is used to accurately represent the pose and shape of the hand in a subsequent mixed pose sequence.
S202: extracting a hand mask image of the reference object and a human skeleton parameter image of the reference object from the driving signal.

The hand mask image refers to a binary image used to distinguish a hand from other parts, as shown in panel c in FIG. 3. The human skeleton parameter image describes positions and orientations of various joints of the human body, which can be used to guide the subsequent generation of the pose of the target object, including facial expressions and body movements, as shown in panel a in FIG. 3.

The human skeleton parameter image of the reference object includes a facial key point of the head of the reference object head and a body key point. The body includes a main body part of the human body excluding the head, including the limbs and trunk.
S203: based on the hand mask image, fusing the human skeleton parameter image and the hand rendering image, to obtain the mixed pose sequence with the hand rendering image as a foreground image.

In an embodiment of the present disclosure, a limited number of key points are used in the human skeleton parameter image to describe the hand movement, but these key points can only express a limited amount of details in hand movements. The hand rendering image, on the other hand, can more accurately and precisely depict hand movements. Therefore, the purpose of fusing the hand rendering image as a foreground image with the human skeleton parameter image is primarily to replace the hand part in the human skeleton parameter image with the hand rendering image, while ensuring that the fused hand rendering image is not obscured by other parts. Other parts in the human skeleton parameter image are still described using the human skeleton parameter image.

The human skeleton parameter image and the hand rendering image are combined by using the hand mask image as a guide to generate a mixed pose sequence, as shown in panel d in FIG. 3. The hand rendering image serves as the foreground image, providing a detailed display of the three-dimensional pose of the hand to minimize the reconstruction loss caused by hand occlusion. The human skeleton parameter image, as a layer behind the foreground, provides an overall pose of the reference object, enabling the generation of high-quality driving data for the poses of the target object.

During implementation, the mixed pose sequence can be obtained through fusion based on the method described in formula (1):

$${I}_{f} = {I}_{b} \times ( 1 - {I}_{m} ) + {I}_{h} \times {I}_{m} \qquad ( 1 )$$

In formula (1), I_{f} represents the mixed pose image, I_{b} represents the human skeleton parameter image, Iₘ represents the hand mask image, and Iₕ represents the hand rendering image.

In an embodiment of the present disclosure, a hand rendering image of the reference object is obtained by inputting the driving signal into the hand pose estimation model, which can significantly enhance the accuracy and robustness of hand pose estimation. Based on the hand mask image, the human skeleton parameter image and the hand rendering image are fused to obtain a mixed pose sequence with the hand rendering image as the foreground image. This approach provides clearer conditional guidance for a hand, thereby improving the stability and accuracy of the hand in the generated video.

In an embodiment of the present disclosure, due to the high density of facial key points, when performing certain actions, such as swinging the head from side to side, the facial key points are prone to being occluded in a side-view profile state. This leads to potential confusion between the key points of different facial parts. To prevent confusion, different highlighting description methods are employed for the key points of different facial parts in the target part of the mixed pose sequence.

During implementation, different colors may be assigned to the key points of different parts. For example, since the distance between eyes and eyebrows is relatively small, the key points surrounding the eyes and the key points of the eyebrows can be distinguished from each other using different colors.

In an embodiment of the present disclosure, distinct highlighting description methods are employed to differentiate between key points of different facial parts in the mixed pose sequence. This enables the model to better distinguish key points of various parts, thereby reconstructing the facial expressions of the target object. By using different colors to distinguish key points of different facial parts, strong conditional guidance is provided for facial expression reconstruction, which enhances the stability and accuracy of the facial expressions of the target object in the video.

In an embodiment of the present disclosure, to improve the stability and accuracy of motion generation, a description value used to represent a human key point in the mixed pose sequence is positively correlated with a confidence level of the key point.

The human key points represent a position of a major human joint in the reference image. By extracting these key points, a basic skeletal structure of the human body can be constructed to guide the motion generation of the digital human (i.e., the target object) in the video. During implementation, the description values of the key points may be represented by brightness; specifically, a higher confidence level of a key point corresponds to a higher brightness value of that key point. These human key points are understood to be the key points in the human skeleton parameter image after fusion with the hand rendering map.

In an embodiment of the present disclosure, for a human key point in the mixed pose sequence, the description value used to represent the key point is positively correlated with the confidence level of the key point, which helps ensure the accuracy and reliability of the key points, reduce errors and uncertainties caused by a low-confidence key point, and guarantee the coherence and naturalness of the motion of the digital human in the generated video of the target object.

In an embodiment of the present disclosure, the reference features of the target object extracted from the reference image include at least one of the following:
(1) an appearance coding feature;
The appearance coding feature primarily focuses on the overall visual appearance of the target object, such as its appearance, clothing, and other texture information.

During implementation, the reference image can be input into the VAE (Variational Autoencoder Encoder), to obtain the appearance encoding feature.
(2) a semantic encoding feature;

The semantic encoding feature focuses on image content, that is, what each part represents in the image. For example, identifying which areas in the reference image correspond to the head, body, background and the like, and understanding their relationships.

During implementation, the reference image can be input into a semantic feature encoder, such as CLIP (Contrastive Language-Image Pretraining Encoder), to obtain the semantic encoding feature.
(3) a local encoding feature; The local encoding feature includes a facial feature and/or a hand feature.

The local encoding feature focuses on details of a specific part in the reference image, such as a facial feature and a hand feature.

In an embodiment of the present disclosure, the appearance encoding feature is particularly helpful in ensuring that a generated video frame visually aligns with the original reference image, thereby enhancing the comprehensibility and coherence of the generated video. The semantic encoding feature facilitates the network's understanding and generation of a logical motion sequence through high-level comprehension of the reference image content, making the generated content more reasonable and natural. The local encoding feature captures details of a specific part in the reference image, enabling further optimization of the generated video frames locally, and resulting in a more accurate and stable local pose.

In some embodiments, extracting a hand feature of the target object from the reference image can be accomplished based on the following steps:
Step A1: extracting a left-hand local image and a right-hand local image of the target object from the reference image;

During implementation, computer vision technology can be utilized to identify and isolate a hand area in the reference image. To ensure the accuracy of subsequent processing, separate local images are typically generated for each hand, namely a left-hand local image and a right-hand local image.
Step A2: inputting the left-hand local image and the right-hand local image into a hand encoder, obtaining the hand feature.

During implementation, the extracted left local image and right-hand local image can be inputted through corresponding channels to combine them into a complete hand image. By distinguishing between the left and right hands through different channels, corresponding condition guidance can be established for each hand, improving the signal quality of the left and right hands. The left-hand local image and the right-hand local image are further inputted into the hand encoder, producing a hand feature, which can include the shape, texture, joint positions, or the like of the hand, facilitating accurate understanding of the hand pose by the neural network model.

To achieve efficient hand feature encoding, the hand encoder can adopt a lightweight convolutional layer design, trained alongside the backbone network, to learn hand feature encoding.

In an embodiment of the disclosure, the left-hand local image and the right-hand local image of the target object are extracted from the reference image and input into a hand encoder to obtain the hand feature. By focusing on the hand area, it can capture the details of the hand more accurately, thus providing more precise hand feature information for the subsequent generation process, making the generated digital human hand motion more natural and realistic.

Correspondingly, extracting a facial feature of the target object from the reference image can be accomplished based on the following steps:
Step B1: extracting a facial local image of the target object from the reference image;

During implementation, a facial local image containing a facial position can be accurately extracted from the reference image based on a facial detection model.
Step B2: inputting the facial local image into a facial encoder, to obtain the facial feature.

Based on the obtained facial local image, it is input into the facial encoder to obtain a facial feature, such as the shape of an eye, the contour of a nose, and the expression of the mouth.

The facial encoder can be constructed using a relatively mature neural network model capable of extracting facial expressions.

In other embodiments, similar to the hand encoder, a facial encoder can also adopt a lightweight convolutional layer design. Alternatively, an existing mature facial encoder can be utilized to accurately extract a facial feature for reconstructing the facial expression of the target object.

In an embodiment of the present disclosure, a facial local image of the target object is extracted from the reference image and input into a facial encoder to obtain a facial feature. By focusing on feature extraction in the facial area, it can capture details of a facial expression detail more accurately, thus providing more precise facial feature information for subsequent generation of a video of the target object, thereby ensuring identity consistency and expression richness.

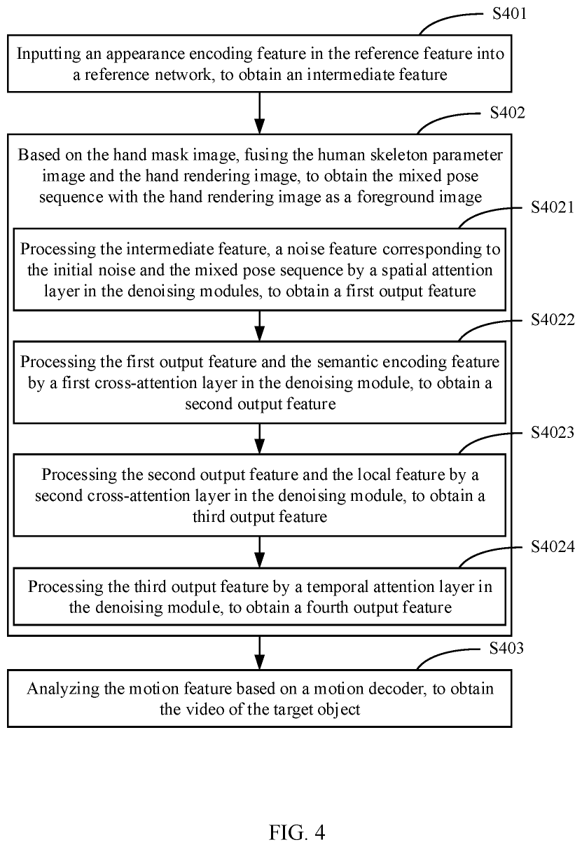

In an embodiment of the present disclosure, as shown in FIG. 4, the method of generating a video of a target object involves introducing initial noise to a denoising network, and performing a reverse denoising operation on the reference feature and the mixed pose sequence, to generate a video of the target object, which includes:
S401, inputting an appearance encoding feature in the reference feature into a reference network, obtaining an intermediate feature.

The reference network is a neural network architecture used in digital human motion generation tasks.

In an embodiment of the disclosure, the primary function of the reference network is to extract an intermediate feature related to the target object from the reference image and pass the feature to a subsequent denoising network.
S402, inputting the intermediate feature, the local feature, initial noise, and the semantic encoding feature into the denoising network for processing, to obtain a motion feature of the target object.

During implementation, the intermediate feature, local feature, initial noise, and semantic encoding feature can be input into the denoising network, where a plurality of denoising modules perform the following operations of:
S4021, processing the intermediate feature, a noise feature corresponding to the initial noise and the mixed pose sequence by a spatial attention layer in the denoising modules, to obtain a first output feature.
S4022, processing the first output feature and the semantic encoding feature by a first cross-attention layer in the denoising modules, to obtain a second output feature.
S4023, processing the second output feature and the local feature by a second cross-attention layer in the denoising modules, to obtain a third output feature.
S4024, processing the third output feature by a temporal attention layer in the denoising modules, to obtain a fourth output feature. Specifically, the fourth output feature outputted by the temporal attention layer of a last denoising module in the denoising network represents the motion feature of the target object.

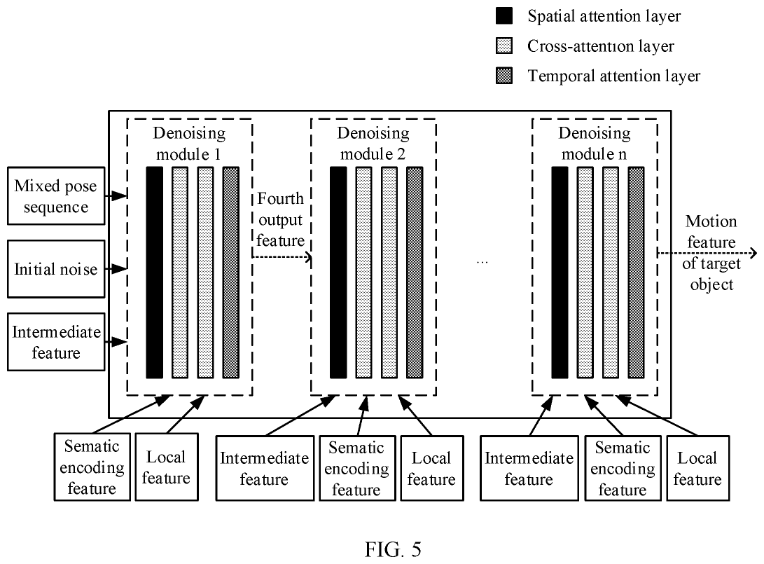

During implementation, as shown in FIG. 5, the intermediate feature, local feature, initial noise, semantic encoding feature, and mixed pose sequence can be input into the denoising module 1 of the denoising network. After processing by attention layers at various levels, the fourth encoded feature is output. Subsequently, the fourth encoded feature output by denoising module 1, along with intermediate feature, semantic encoding feature, and local feature, are input into denoising module 2 to obtain a new fourth output feature. By analogy, the output feature of each denoising module will serve as one of the inputs for the next module, and ultimately, the motion feature of the target object is output by denoising module n.

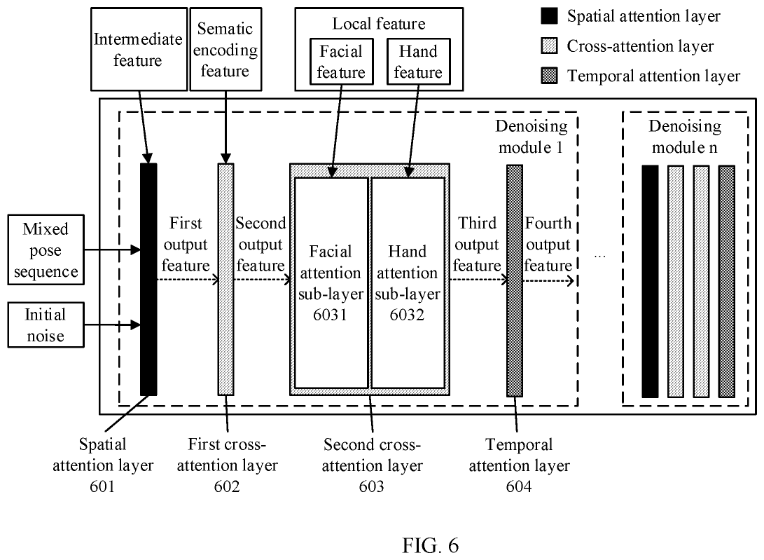

To illustrate the processing flow of the denoising network more clearly, the processing flow of a denoising module 1 is taken as an example for detailed explanation. As shown in FIG. 6, the obtained intermediate feature, noise feature corresponding to the initial noise, and mixed pose sequence are inputted into the denoising module 1 of the denoising network. The first output feature is obtained through a spatial attention layer 601. Then, the obtained first feature and the semantic encoding feature are inputted into a first cross-attention layer 602, where the first feature is further optimized based on the semantic information of the semantic encoding feature, resulting in the second output feature. The obtained second feature and local feature are then inputted into a second cross-attention layer 603, where the local feature is fused into the second feature, to obtain a third output feature. Finally, the third output feature is inputted into a temporal attention layer 604, resulting in the fourth output feature.

It should be noted that the denoising network and the reference network in the embodiment of the present disclosure have corresponding structures. Each denoising module in the denoising network corresponds one-to-one with a feature construction module in the reference network.

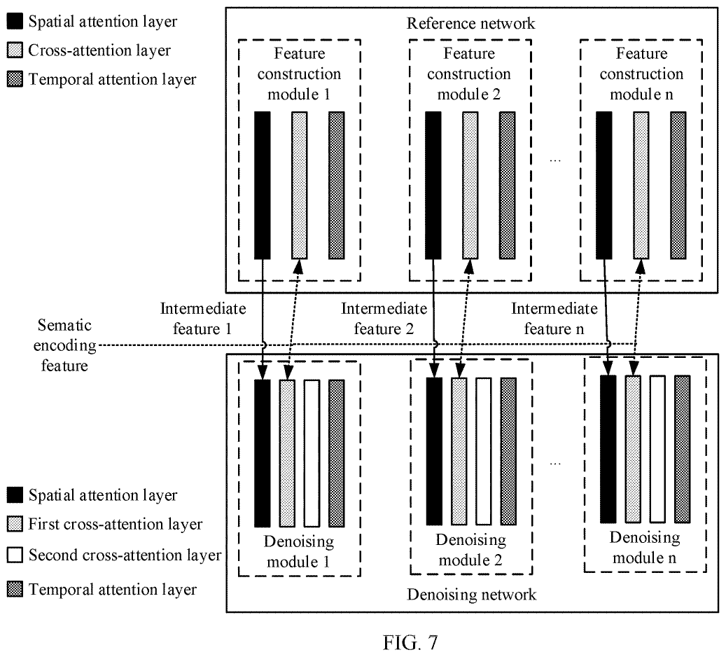

In one possible implementation, as shown in FIG. 7, the reference network includes a plurality of feature construction modules sequentially connected, each of which includes a spatial attention layer, a cross-attention layer, and a temporal attention layer sequentially connected. The output of the spatial attention layer of the reference network is used as an intermediate feature and input to a corresponding denoising module in the denoising network. For example, the intermediate feature 1 output by the spatial attention layer in the first feature construction module of the reference network is input to the spatial attention layer of the first denoising module in the denoising network. The intermediate feature 2 output by the spatial attention layer in the second feature construction module of the reference network is input to the spatial attention layer of the second denoising module in the denoising network. Similarly, the intermediate feature n output from the spatial attention layer of the nth feature construction module in the reference network is input to the spatial attention layer of the nth denoising module in the denoising network.

Referring to FIG. 7, the semantic encoding feature is input to the denoising module in the denoising network, in the meantime being input to the feature construction module corresponding to the denoising module in the reference network. In this way, the reference network can continuously optimize the intermediate feature in subsequent feature construction modules, improving the accuracy and stability of the reconstructed pose of the target object.

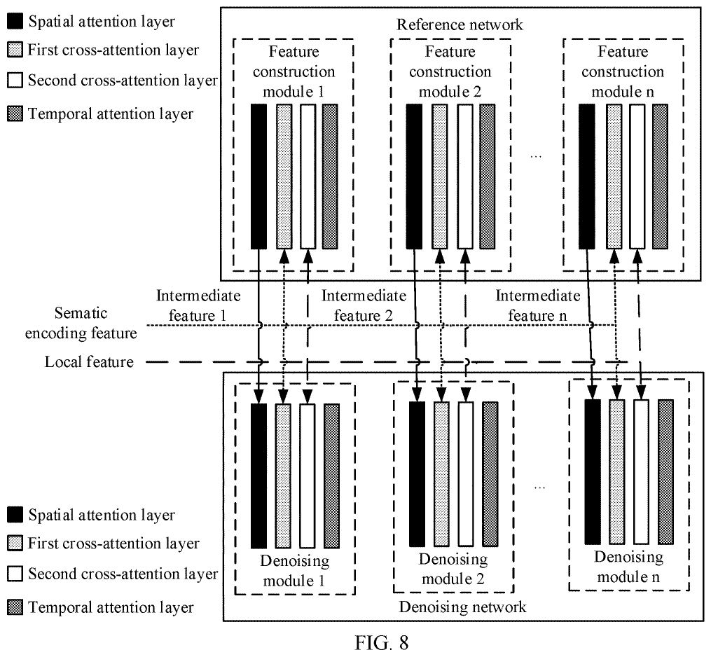

FIG. 7 shows different structures of the feature construction module and the denoising module. In other embodiments, the feature construction module and the denoising module may have the same network structure. As shown in FIG. 8, the feature construction module, like the denoising module, can have a spatial attention layer, first cross-attention layer, second cross-attention layer, and temporal attention layer, with the difference being that the model parameters of the two modules are independent.

In FIG. 8, the processing method of the intermediate feature and semantic encoding feature is the same as in FIG. 7. The difference is that the feature construction module and the corresponding denoising module in FIG. 8 share the local feature. That is to say, as shown in FIG. 8, the local feature is not only input to the denoising module for processing, but also to the second cross-attention layer of the corresponding feature construction module for processing, in order to improve the quality of the intermediate feature.

In an embodiment of the present disclosure, the spatial attention layer can automatically learn the importance weights of input features at different spatial positions, thereby improving the model's ability to capture and express the motion of a key part. The cross-attention layer enables the model to better understand the correlations and dependencies between different features through their interactions. The second cross-attention layer further fuses the local feature, which can use more local information guidance to improve the accuracy of local information construction; The temporal attention layer can ensure that the generated motion has coherence and naturalness in the temporal dimension, avoiding abrupt or uncoordinated motion transitions. Accordingly, the attention layers at each level can progressively refine and optimize the respective input features, enabling the finally obtained motion feature to reconstruct the motion intentions and details of the target object more accurately.

Furthermore, in the case where the local feature includes a facial feature and a hand feature, the denoising module processes the facial feature based on a facial attention sub-layer in the second cross-attention layer, and processes the hand feature based on a hand attention sub-layer.

As shown in FIG. 6, the facial attention sub-layer 6031 is specifically designed to process a facial feature, aiming to enhance the expressiveness of details such as facial expressions and poses. Based on the input of the second output feature and the facial feature, a cross-attention mechanism is used to dynamically adjust the importance weights of the facial feature, enabling the model to capture subtle facial changes more accurately.

The hand attention sub-layer 6032 focuses on processing the hand feature, with the aim of capturing and enhancing details such as finger position and gesture morphology. Based on the input of the second output feature and the facial feature, a cross-attention mechanism is used to dynamically adjust the importance weights of the hand feature to ensure the smoothness and naturalness of the motion of the hand.

It should be noted that in the denoising module, the facial feature is processed based on the facial attention sub-layer in the second cross-attention layer, and the hand feature is processed based on the hand attention sub-layer. There is no order of processing between the two.

In an embodiment of the present disclosure, by using facial attention sub-layer and hand attention sub-layer separately, it can optimize the performance of the face and hand independently and accurately without affecting the features of other body parts.
S403: analyzing the motion feature based on a motion decoder, to obtain the video of the target object.

That is, the abstract motion feature is restored into a concrete video frame through a motion decoder, to obtain the video of the target object.

In an embodiment of the present disclosure, by combining the appearance encoding feature, local feature, initial noise, and semantic encoding feature, the denoising network can generate a richer and more realistic motion feature; The appearance encoding feature provides overall appearance information of the target object; The local feature focuses on a detailed part; The initial noise introduces randomness to increase diversity; The semantic encoding feature provides semantic information for motions and poses. This fusion of multi-source information makes the generated motion feature more comprehensive and accurate, thereby improving the quality of the generated video and maintaining consistency and coherence between different frames.

In an embodiment of the present disclosure, a human key point in the mixed pose sequence is aligned with a human key point of the target object.

Human key points are used to describe the pose of a reference object in a mixed pose sequence. The human key points of the target object refer to the pose of the target object extracted from the reference image. Aligning human key points in a mixed pose sequence with those of the target object refers to matching and adjusting the human key points of the reference object and the human key points of the target object in the mixed pose sequence to ensure consistency in body proportions, motion amplitudes, and other aspects.

For example, if the target object is tall and thin while the human key points in the mixed pose sequence originate from a shorter and heavier individual, the alignment process can adjust the positions of the key points to make the motion of the generated digital human more consistent with the physical characteristics of the target object.

In an embodiment of the present disclosure, by aligning the human key points in the mixed pose sequence with the human key points of the target object, it can be ensured that the generated digital human is consistent with the target object in terms of body proportions, thereby ensuring the coherence and consistency of the motions.

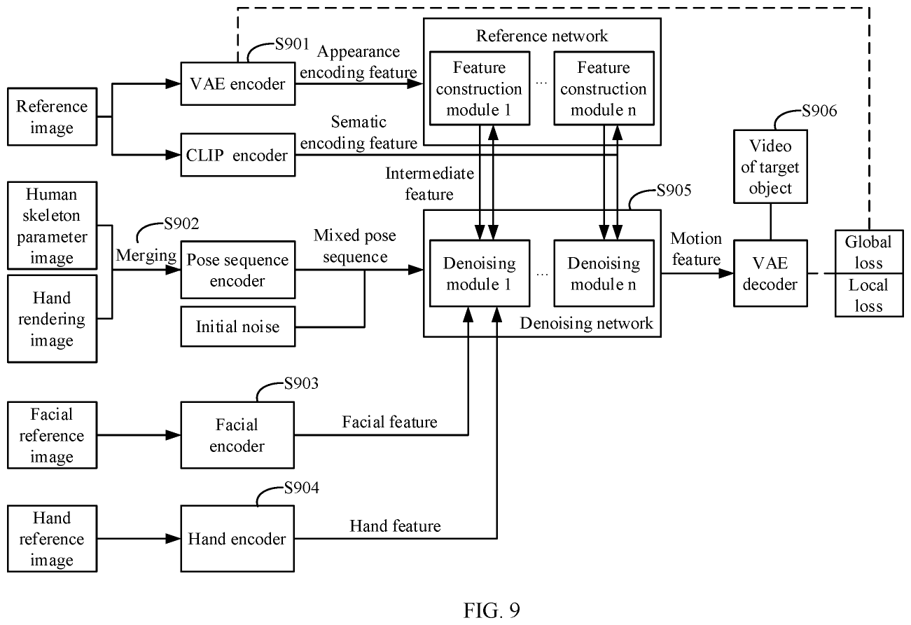

In summary, the overall flow of the video generation method provided in an embodiment of the present disclosure is illustrated in FIG. 9:
S901: Taking a reference image as one of the inputs, obtaining the appearance encoding feature through a VAE encoder and obtaining the semantic encoding feature through a CLIP encoder; and inputting the appearance encoding feature into the reference network, obtaining an intermediate feature.
S902: extracting human key points from a driving video, obtaining a human skeleton parameter image, and performing fusion processing after extracting the hand rendering image, obtaining the mixed pose sequence.

The higher the confidence level of a key point is, the higher brightness it has. The hand rendering map is extracted by a hand pose estimation model HaMer. This model utilizes a 3D parametric hand mesh model, MANO, which, through hand pose estimation, is eventually rendered into a 3D gray-model image of the hand. In order to distinguish between the left and right hands, the left-hand and the right-hand are distinguished by different colors. Subsequently, the human skeleton parameter image and hand rendering image are fused to obtain the mixed pose sequence with the hand rendering image as the foreground image.

By adding a local attention mechanism, specifically in S903, a facial encoder is used to embed a facial local feature for the facial local area of the target object. In S904, for the hand of the target object, the corresponding hand area is extracted and input into the hand encoder, extracting the hand feature of the target object.

The extracted hand feature of the target object refers to a feature extracted from the local area of the target object's hand that can represent its hand pose. These features include but are not limited to the shape of the hand, the pose of the fingers, the movement trend of the hand, and the texture of the hand.

Correspondingly, the facial feature refers to a feature extracted from the local facial areas of the target object that can represent its identity, expression, pose, and other information. These features cover the details of the facial feature, such as the degree of eye opening and closing, the shape and position of the mouth, as well as the overall contour and skin texture of the face.

Based on the above description, in the process of feature extraction, the extraction of facial and hand features is not limited to serving as inputs for the denoising network. It can also be used as input to the reference network, similar to the semantic encoding feature. For example, inputting the facial feature into the reference network can enable the reference network to fully consider the details of the facial feature during feature extraction; Inputting the hand feature into the reference network can provide detailed feature descriptions about the hand, enabling the reference network to capture the details of the hand feature more accurately. Thus, inputting facial and hand features into the reference network can provide richer information and diverse feature angles for the reference network, thereby enhancing the overall feature expression and task processing capabilities of the model, making the generated video of the target object more natural and realistic.
S905: inputting an intermediate feature, a local feature, initial noise and a semantic encoding feature, as well as a pose sequence into the denoising network, and inputting the local feature into the reference network, processed by the denoising network, obtaining the motion feature of the target object.
S906: analyzing the motion feature based on a motion decoder, to obtain the video of the target object.

Based on the network structure shown in FIG. 9, in the embodiment of the present disclosure, the denoising network, the reference network, a modal encoding network for obtaining the semantic feature of the target object, and a hand encoding network for extracting the hand feature are obtained by optimization through training samples.

In an embodiment of the present disclosure, by training and optimizing the denoising network, its network parameters can be optimized, improving its robustness to noise and ability to restore details, thereby making the generated video more authentic. Training and optimizing the reference network can enable it to extract and utilize features from the reference image more effectively, thereby improving the accuracy and coherence of the generated results. Training and optimizing the modal encoding network used to obtain the semantic feature of the target object can optimize the fusion strategy, improve the quality and guidance of the generated pose image. Training and optimizing the hand encoding network used for extracting the hand feature can better capture the key hand feature and effectively encode it into a feature vector that can be used for generation.

In an embodiment of the present disclosure, a loss function required for training and optimizing the network includes at least one of the following losses:
(1) a pixel loss across the entire image range between an image frame in the generated video and a corresponding true value image;

That is to calculate a pixel difference between each frame image in the generated video and the corresponding real image within the entire image range. During implementation, the loss can be calculated based on the Mean Squared Error (MSE) loss.
(2) a first local pixel loss between a face in the image frame of the generated video and a face in the true value image;

That is specifically used to measure the pixel differences between the facial part of the frame image in the generated video and the face of the real image. During implementation, the pixel difference can still be calculated based on the MSE loss.
(3) a second local pixel loss between a hand in the image frame of the generated video and a hand in the true value image.

That is, specifically, pixel differences are calculated for the hand area in the generated image and the real image.

In an embodiment of the present disclosure, the pixel loss within the entire image range between the image frame in the generated video and the corresponding truth image can ensure that the generated entire image is as close as possible to the real image as a whole, maintaining global visual consistency. The first local pixel loss between the face in the image frame of the generated video and the face in the true value image can help the model better capture and restore subtle changes in the face, improving the quality of the facial area in the generated video. The second local pixel loss between the hand in the image frame of the generated video and the hand in the true value image can optimize details such as hand pose and joint position, ensuring the naturalness and accuracy of hand motions, making the hand area clearer and more realistic.

As shown in FIG. 9, the training loss function will be constrained in a hidden space. In addition to the normal MSE loss (global loss), an additional Mask loss (local loss) will be added, which is a MSE loss constraint for the hand and facial areas, to increase the supervision of the face and hand.

In summary, the video generation method provided in the present disclosure can improve the stability and effectiveness of hand and body movements through a mixed posture condition guidance. At the same time, facial feature embedding is introduced to enhance the quality of face generation, and based on a temporal diffusion model, stable and temporally consistent human motion generation video effects can be generated.

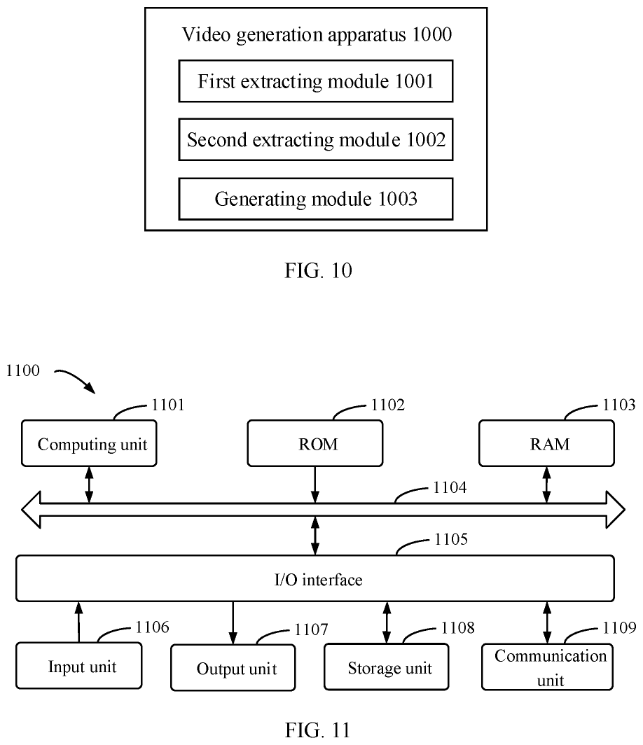

Based on the same technical concept, an embodiment of the present disclosure further provides a video generation apparatus 1000, as shown in FIG. 10, which includes:
a first extracting module 1001 configured to extract a reference feature of a target object from a reference image;
a second extracting module 1002 configured to determine a mixed pose sequence;
wherein a plurality of target parts in the mixed pose sequence adopt a corresponding description mode to enhance a pose characteristic of a corresponding part;
a generating module 1003 configured to introduce initial noise to a denoising network and perform a reverse denoising operation on the reference feature and the mixed pose sequence, to generate a video of the target object.

In some embodiments, the plurality of target parts in the mixed pose sequence include at least one of the following: face, hand, or parts of the body other than the hand.

In some embodiments, a three-dimensional grayscale model is used for the hand in the target part of the mixed pose sequence.

In some embodiments, the left and right hands of the target part in the mixed pose sequence are distinguished using different colors.

In some embodiments, the second extracting module comprises:
an output unit configured to input a driving signal into a hand pose estimation model, to obtain a hand rendering image of the reference object in the driving signal output by the hand pose estimation model; wherein the hand rendering image is used to describe a three-dimensional mesh parameter of the hand of the reference object;
an extracting unit configured to extract a hand mask image of the reference object and a human skeleton parameter image of the reference object from the driving signal;
a fusing unit configured to fuse the human skeleton parameter image and the hand rendering image based on the hand mask image, to obtain the mixed pose sequence with the hand rendering image as a foreground image.

In some embodiments, for the face in the target part in the mixed mode sequence, different highlighting description methods are used for key points of different parts of the face.

In some embodiments, for human key points in the mixed pose sequence, a description value used to describe a key point is positively correlated with the confidence of the key point.

In some embodiments, the reference feature of the target object includes at least one of the following: an appearance encoding feature, a semantic encoding feature, or a local encoding feature.

The local encoding feature includes a facial feature and/or hand feature.

In some embodiments, the first extracting module comprises:
extracting a left-hand local image and a right-hand local image of the target object from the reference image;
inputting the left-hand local image and the right-hand local image into a hand encoder, obtaining a hand feature.

In some embodiment, extracting a facial feature of the target object from the reference image comprises:
a face obtaining unit configured to extract a facial local image of the target object from the reference image;
a face encoding unit configured to input the facial local image into a facial encoder, obtaining a facial feature.

In some embodiments, the generating module comprises:
a first processing unit configured to input an appearance encoding feature in the reference feature into a reference network, obtaining an intermediate feature;
a second processing unit configured to input the intermediate feature, the local feature, the initial noise, and the semantic encoding feature into the denoising network for processing, to obtain a motion feature of the target object;
a decoding unit configured to analyze the motion feature based on a motion decoder, to obtain the video of the target object.

In some embodiments, the second processing unit is specifically configured to:
input the intermediate feature, the local feature, the initial noise, and the semantic encoding feature into the denoising network for a plurality of denoising modules in the denoising network to perform the following operations of:
processing the intermediate feature, a noise feature corresponding to the initial noise and the mixed pose sequence by a spatial attention layer in the denoising modules, to obtain a first output feature;
processing the first output feature and the semantic encoding feature by a first cross-attention layer in the denoising modules, to obtain a second output feature;
processing the second output feature and the local feature by a second cross-attention layer in the denoising modules, to obtain a third output feature;
processing the third output feature by a temporal attention layer in the denoising modules, to obtain a fourth output feature;
wherein, the fourth output feature outputted by the temporal attention layer of a last denoising module in the denoising network represents the motion feature of the target object.

In some embodiments, the second processing unit is specifically configured to, in a case where the local feature includes the facial feature and the hand feature, process the facial feature based on a facial attention sub-layer in the second cross-attention layer in the denoising module, and process the hand feature based on a hand attention sub-layer.

In some embodiments, the denoising network, the reference network and a modal encoding network for obtaining the semantic feature of the target object, and a hand encoding network for extracting the hand feature are obtained by optimization through training samples.

In some embodiments, a loss function required for training and optimizing the network includes at least one of the following losses:
a pixel loss across the entire image range between an image frame in the generated video and a corresponding true value image;
a first local pixel loss between a face in the image frame of the generated video and a face in the true value image; or a second local pixel loss between a hand in the image frame of the generated video and the hand in the true value image.

In some embodiments, a human key point in the mixed pose sequence is aligned with a human key point of the target object.

For the specific functions and examples of each module and sub-module of the apparatus of the embodiments of the present disclosure, reference can be made to the relevant descriptions of the corresponding steps in the aforementioned method embodiments, which will not be further elaborated here.

In the disclosed technical solution, the obtaining, storage, and application of user personal information involved are all in compliance with relevant laws and regulations, and do not violate public order and good customs.

According to an embodiment disclosed herein, the present disclosure further provides an electronic device, a readable storage medium, and a computer program product.

FIG. 11 is a structural block diagram of an electronic device 1100 that can implement the embodiments of the present disclosure. Electronic devices are intended to represent various forms of digital computers, such as laptop computers, desktop computers, workstations, personal digital assistants, servers, blade servers, mainframes, and other suitable computers. Electronic devices may also represent various forms of mobile apparatuses, such as personal digital assistants, cellular telephones, smartphones, wearable devices, and other similar computing apparatuses. The components, their connections and relationships, and their functions illustrated herein are provided merely as examples, and are not intended to limit the implementation of the disclosure described and/or claimed herein.

As shown in FIG. 11, the device 1100 includes a computing unit 1101, which may perform various appropriate actions and processes according to a computer program stored in a Read-Only Memory (ROM) 1102 or a computer program loaded from a storage unit 1108 into a Random Access Memory (RAM) 1103. In the RAM 1103, various programs and data required for the operation of the device 1100 may also be stored. The computing unit 1101, the ROM 1102, and the RAM 1103 are connected to each other through a bus 1104. An Input/Output (I/O) interface 1105 is also connected to the bus 1104.

A plurality of components in the device 1100 are connected to the I/O interface 1105, including: an input unit 1106, such as a keyboard, a mouse, or the like; an output unit 1107, such as various types of displays, speakers, or the like; a storage unit 1108, such as a magnetic disk, an optical disk, or the like; and a communication unit 1109, such as a network card, a modem, a wireless communication transceiver, or the like. The communication unit 1109 allows the device 1100 to exchange information/data with other devices through a computer network such as the Internet and/or various telecommunication networks.

The computing unit 1101 may be various general-purpose and/or special-purpose processing components having processing and computing capabilities. Some examples of the computing unit 1101 include, but are not limited to, a Central Processing Unit (CPU), a Graphics Processing Unit (GPU), various special-purpose Artificial Intelligence (AI) computing chips, various computing units running machine learning model algorithms, a Digital Signal Processor (DSP), and any appropriate processors, controllers, microcontrollers, or the like. The computing unit 1101 performs the various methods and processes described above, such as the video generation method. For example, in some embodiments, the video generation method may be implemented as a computer software program tangibly contained in a machine-readable medium, such as the storage unit 1108. In some embodiments, part or all of the computer program may be loaded and/or installed onto the device 1100 via the ROM 1102 and/or the communication unit 1109. When the computer program is loaded into the RAM 1103 and executed by the computing unit 1101, one or more steps of the video generation method described above may be performed. Alternatively, in other embodiments, the computing unit 1101 may be configured to perform the video generation method in any other appropriate manner (e.g., by means of firmware).”

Various implementations of the systems and technologies described hereinabove may be implemented in digital electronic circuitry, integrated circuit systems, Field Programmable Gate Arrays (FPGAs), Application Specific Integrated Circuits (ASICs), Application-Specific Standard Products (ASSPs), System-on-Chip (SOC) systems, Complex Programmable Logic Devices (CPLDs), computer hardware, firmware, software, and/or combinations thereof. These various implementations may include: being implemented in one or more computer programs that are executable and/or interpretable on a programmable system including at least one programmable processor, which may be a special-purpose or general-purpose programmable processor, and which may receive data and instructions from a storage system, at least one input apparatus, and at least one output apparatus, and transmit data and instructions to the storage system, the at least one input apparatus, and the at least one output apparatus.

Program code for implementing the method of the present disclosure may be written in any combination of one or more programming languages. Such program code may be provided to a processor or controller of a general-purpose computer, a special-purpose computer, or other programmable data processing apparatuses, such that the program code, when executed by the processor or controller, causes the functions/operations specified in the flowcharts and/or block diagrams to be implemented. The program code may be executed entirely on a machine, partly on a machine, as a stand-alone software package partly on a machine and partly on a remote machine, or entirely on a remote machine or server.

In the context of the present disclosure, a machine-readable medium may be a tangible medium that may contain or store a program for use by an instruction execution system, apparatus, or device, or the combination thereof. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of the machine-readable storage medium would include an electrical connection based on one or more wires, a portable computer diskette, a hard disk, a Random Access Memory (RAM), a Read-Only Memory (ROM), an Erasable Programmable Read-Only Memory (EPROM or a flash memory), an optical fiber, a portable Compact Disk Read-Only Memory (CD-ROM), an optical storage device, a magnetic storage device, or any suitable combination thereof.

To provide interaction with a user, the systems and technologies described herein may be implemented on a computer having: a display apparatus for displaying information to the user (e.g., a Cathode Ray Tube (CRT) or a Liquid Crystal Display (LCD) monitor); and a keyboard and a pointing apparatus (e.g., a mouse or a trackball) through which the user may provide input to the computer. Other kinds of apparatuses may also be used to provide interaction with a user; for example, feedback provided to the user may be any form of sensory feedback (e.g., visual feedback, auditory feedback, or tactile feedback); and input from the user may be received in any form (including acoustic input, voice input, or tactile input).

The systems and technologies described herein may be implemented in a computing system that includes a back-end component (e.g., as a data server), or a computing system that includes a middleware component (e.g., an application server), or a computing system that includes a front-end component (e.g., a user computer having a graphical user interface or a web browser through which a user may interact with an implementation of the systems and technologies described herein), or a computing system that includes any combination of such back-end, middleware, or front-end components. The components of the system may be interconnected through any form or medium of digital data communication (e.g., a communication network). Examples of communication networks include a Local Area Network (LAN), a Wide Area Network (WAN), and the Internet.

A computing system may include a client and a server. The client and the server are generally remote from each other and typically interact through a communication network. The relationship between the client and the server is generated by computer programs running on respective computers and having a client-server relationship with each other. The server may be a cloud server, a server of a distributed system, or a server combined with blockchain.

It should be understood that the various forms of processes shown above may be used to reorder, add, or delete steps. For example, the steps described in the present disclosure may be performed in parallel, sequentially, or in a different order, as long as the desired results of the technical solutions disclosed in the present disclosure can be achieved, which is not limited herein.

The specific implementations described above do not constitute a limitation on the protection scope of the present disclosure. Those skilled in the art should understand that various modifications, combinations, sub-combinations, and substitutions may be made according to design requirements and other factors. Any modifications, equivalent substitutions, and improvements made within the principles of the present disclosure shall be included within the protection scope of the present disclosure.

What is claimed is:

1. A video generation method, comprising:
extracting a reference feature of a target object from a reference image;
determining a mixed pose sequence; wherein a plurality of target parts in the mixed pose sequence adopt a corresponding description mode to enhance a pose characteristic of a corresponding part;
introducing initial noise to a denoising network, and performing a reverse denoising operation on the reference feature and the mixed pose sequence, to generate a video of the target object.

2. The method of claim 1, wherein the plurality of target parts in the mixed pose sequence include at least one of the following: face, hand, or parts of the body other than the hand.

3. The method of claim 2, wherein the hand in the target part of the mixed pose sequence adopts a three-dimensional grayscale model.

4. The method of claim 2, wherein the left-hand and the right-hand of the hands of the target part in the mixed pose sequence are distinguished using different colors.

5. The method of claim 2, wherein the determining of the mixed pose sequence comprises:
inputting a driving signal into a hand pose estimation model, to obtain a hand rendering image of the reference object in the driving signal output by the hand pose estimation model; wherein the hand rendering image is used to describe a three-dimensional mesh parameter of the hand of the reference object;
extracting a hand mask image of the reference object and a human skeleton parameter image of the reference object from the driving signal;
fusing the human skeleton parameter image and the hand rendering image based on the hand mask image, to obtain the mixed pose sequence with the hand rendering image as a foreground image.

6. The method of claim 2, wherein for the face in the target part in the mixed mode sequence, different highlighting description methods are used for key points of different parts of the face.

7. The method of claim 1, wherein for a human key point in the mixed pose sequence, a description value used to describe a key point is positively correlated with the confidence level of the key point.

8. The method of claim 1, wherein the reference feature of the target object includes at least one of the following: an appearance encoding feature, a semantic encoding feature, or a local encoding feature;
wherein, the local encoding feature includes a facial feature and/or hand feature.

9. The method of claim 8, wherein the extracting of the hand feature of the target object from the reference image comprises:
extracting a left-hand local image and a right-hand local image of the target object from the reference image;
inputting the left-hand local image and the right-hand local image into a hand encoder, obtaining the hand feature.

10. The method of claim 8, wherein the extracting of the facial feature of the target object from the reference image comprises:
extracting a facial local image of the target object from the reference image;
inputting the facial local image into a facial encoder, to obtain the facial feature.

11. The method of claim 8, wherein introducing the initial noise to the denoising network, and performing the reverse denoising operation on the reference feature and the mixed pose sequence, to generate the video of the target object, comprises:
inputting an appearance encoding feature in the reference feature into a reference network, obtaining an intermediate feature;
inputting the intermediate feature, the local feature, the initial noise, and the semantic encoding feature into the denoising network for processing, to obtain a motion feature of the target object;
analyzing the motion feature based on a motion decoder, to obtain the video of the target object.

12. The method of claim 11, wherein the inputting of the intermediate feature, the local feature, the initial noise, and the semantic encoding feature into the denoising network for processing, to obtain the motion feature of the target object, comprises:
inputting the intermediate feature, the local feature, the initial noise, and the semantic encoding feature into the denoising network for a plurality of denoising modules in the denoising network to perform the following operations of:
processing the intermediate feature, a noise feature corresponding to the initial noise and the mixed pose sequence by a spatial attention layer in the denoising modules, to obtain a first output feature;
processing the first output feature and the semantic encoding feature by a first cross-attention layer in the denoising modules, to obtain a second output feature;
processing the second output feature and the local feature by a second cross-attention layer in the denoising modules, to obtain a third output feature;
processing the third output feature by a temporal attention layer in the denoising modules, to obtain a fourth output feature;
wherein, the fourth output feature outputted by the temporal attention layer of a last denoising module in the denoising network represents the motion feature of the target object.

13. The method of claim 12, wherein in a case where the local feature includes the facial feature and the hand feature, the facial feature is processed based on a facial attention sub-layer in the second cross-attention layer in the denoising module, and the hand feature is processed based on a hand attention sub-layer.

14. The method of claim 12, wherein the denoising network, the reference network and a modal encoding network for obtaining the semantic feature of the target object, and a hand encoding network for extracting the hand feature are obtained by optimization through training samples.

15. The method of claim 14, wherein a loss function required for training and optimizing the network includes at least one of the following losses:
a pixel loss across the entire image range between an image frame in the generated video and a corresponding true value image;
a first local pixel loss between a face in the image frame of the generated video and a face in the true value image; or
a second local pixel loss between a hand in the image frame of the generated video and the hand in the true value image.

16. The method of claim 1, wherein a human key point in the mixed pose sequence is aligned with a human key point of the target object.

17. An electronic device, comprising:
at least one processor; and
a memory connected in communication with the at least one processor;
wherein the memory stores an instruction executable by the at least one processor, and the instruction, when executed by the at least one processor, enables the at least one processor to execute:
extracting a reference feature of a target object from a reference image;
determining a mixed pose sequence; wherein a plurality of target parts in the mixed pose sequence adopt a corresponding description mode to enhance a pose characteristic of a corresponding part;
introducing initial noise to a denoising network, and performing a reverse denoising operation on the reference feature and the mixed pose sequence, to generate a video of the target object.

18. The electronic device of claim 17, wherein the plurality of target parts in the mixed pose sequence include at least one of the following: face, hand, or parts of the body other than the hand.

19. A non-transitory computer-readable storage medium storing a computer instruction thereon, wherein the computer instruction is used to cause a computer to execute:
extracting a reference feature of a target object from a reference image;
determining a mixed pose sequence; wherein a plurality of target parts in the mixed pose sequence adopt a corresponding description mode to enhance a pose characteristic of a corresponding part;
introducing initial noise to a denoising network, and performing a reverse denoising operation on the reference feature and the mixed pose sequence, to generate a video of the target object.

20. The non-transitory computer-readable storage medium of claim 19, wherein the plurality of target parts in the mixed pose sequence include at least one of the following: face, hand, or parts of the body other than the hand.
